(19) United States
(12) Patent Application Publication
(10) Pub. No.: US 2021/0389447 A1
(43) Pub. Date: Dec. 16, 2021

(54) METHOD AND APPARATUS FOR NON-LINE OF SIGHT RADAR

(71) Applicant: Metawave Corporation, Carlsbad, CA (US)

(72) Inventors: Soren SHAMS, Carlsbad, CA (US); Maha ACHOUR, Encinitas, CA (US); Kenneth Ray CARROLL, Huntington Beach, CA (US); Abdullah Ahsan ZAIDI, San Diego, CA (US); Taha SHAHVIRDI DIZAJ YEKAN, San Diego, CA (US); Narek ROSTOMYAN, San Diego, CA (US); Hratchia Tom ZARIAN, San Diego, CA (US)

(21) Appl. No.: 17/347,012

(22) Filed: Jun. 14, 2021

Related U.S. Application Data
(60) Provisional application No. 63/038,697, filed on Jun. 12, 2020.

(51) Int. Cl. G01S 13/75; G01S 13/931

(52) U.S. Cl. CPC G01S 13/75; G01S 2013/9328; G01S 13/931

(57) ABSTRACT

In accordance with various implementations, a radar system comprising a non-line of sight (NLOS) module to enhance operation of the radar system is provided. In various embodiments, the NLOS module is a radar repeater module with phase shifters to generate an indication of an object detected in a NLOS area. In various embodiments, the NLOS module includes a reflector structure configured to reflect or redirect radar signals from a train on the tracks into a NLOS area. The NLOS module can include a receive antenna, a transmit antenna configured to transmit one or more received radar signals into a NLOS area, and a phase shifting module for applying a phase shift to a radar signal reflected from an object in the NLOS area that is outside an operational range of the radar unit.

### CROSS-REFERENCE TO RELATED APPLICATIONS

This application claims the benefit of U.S. Provisional Application No. 63/038,697 filed on Jun. 12, 2020, which is incorporated by reference in its entirety for all purposes.

### BACKGROUND

Radar technology enables visibility into the path of a vehicle, such as an automobile or train in a variety of conditions. There is a need to see in a non-line of sight path of a vehicle, such as for a train going through a tunnel or around a curvature in the tracks. In this situation, the radar may have a limited angular transmission range and therefore may not be configured to detect objects in the path of the vehicle. The vehicle will need enhanced visibility to anticipate objects and conditions ahead.

### BRIEF DESCRIPTION OF THE DRAWINGS

The present application may be more fully appreciated in connection with the following detailed description taken in conjunction with the accompanying drawings, which are not drawn to scale, in which like reference characters refer to like parts throughout, and in which:

FIG. 1 illustrates a radar repeater system, in accordance with one or more implementations of the subject technology;

FIG. 2 illustrates a radar repeater system, in accordance with one or more implementations of the subject technology;

FIG. 3 illustrates signal flow in a radar repeater system, in accordance with one or more implementations of the subject technology;

FIG. 4 illustrates a flow diagram of operation of a radar repeater system in accordance with one or more implementations of the subject technology;

FIG. 5 illustrates a phase shifter module in accordance with one or more implementations of the subject technology;

FIG. 6 illustrates a schematic diagram of a radar phased array system with a phase shifter module in accordance with one or more implementations of the subject technology;

FIG. 7 illustrates a schematic diagram of a radar phased array system with beamformer integrated circuit package tiles in accordance with one or more implementations of the subject technology;

FIG. 8 illustrates in flow diagram for operation of a radar module in accordance with one or more implementations of the subject technology;

FIG. 9 illustrates a signal flow diagram for a radar repeater system in accordance with one or more implementations of the subject technology.

FIG. 10 illustrates a flow diagram for operation of a radar repeater system in accordance with one or more implementations of the subject technology;

FIG. 11 illustrates a radar reflector system in accordance with one or more implementations of the subject technology;

FIG. 12 illustrates a reflectarray in accordance with one or more implementations of the subject technology;

FIG. 13 illustrates a process for designing a reflectarray in accordance with one or more implementations of the subject technology

FIG. 14 illustrates is a signal flow diagram for operation of a radar module and reflectarray according to one or more implementations of the subject technology;

FIG. 15 illustrates a process for radar operation with a reflectarray in accordance with one or more implementations of the subject technology;

FIG. 16 illustrates a reflectarray geometry in accordance with one or more implementations of the subject technology; and

FIG. 17 illustrates a flowchart for an example method of using a radar system in accordance with one or more implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

The present invention relates to applications for radar and phase shifter modules in various applications. As detailed herein, the application is for vehicular, and in particular train systems; however, alternate applications include a wide variety of systems requiring increased visibility in non-line of sight paths.

In accordance with various embodiments, a radar system that includes a radar repeater system is provided. Such radar system includes a stationary repeater module positioned at a non-linear location, i.e., a location not along a straight line, or a curved location, or other location proximate an area of limited visibility, is configured to interact with a radar module positioned on a moving vehicle, such as a train. The stationary repeater module (also referred to herein as a “repeater”) is a device that receives and transmits electromagnetic signals and includes phase shifters to adjust frequency of received signals. The repeater includes one or more amplifiers to increase the gain of transmit signals. Phase shifters in a given repeater can be configured to assign a signature frequency or phase shift to that repeater, and thereby provide specific frequency responses by which a receiving radar unit may identify target locations. The radar module transmits at a modulated signal at first frequency, the repeater receives the radar transmission, phase shifts the signal and returns the phase shifted signal. In a radar system, the modulated transmission signal is compared to the returned phase shifted signal to determine a frequency difference between the two signals. This is referred to as the Doppler frequency and to distinguish the repeater from a reflection of an object the frequency difference for the phase shifted signal is intentionally set to a higher value than possible with a radar reflection. In other words, the Doppler frequency would correspond to an impossible velocity of the repeater and thus would not be identified as a target. In this way, the radar system recognizes the repeater as a part of the radar repeater system and not as a target. Further reflections received from the repeater are then identified as non-line of sight signals. The repeater will transmit in a direction within a non-line of sight area of the radar; any object in that direction will be reflected back through the repeater to the radar at a phase shift indicating that an object is on the tracks (e.g., along the path of the moving vehicle). In some embodiments, the radar can be configured to calculate a distance or a range of distance from the repeater to the object.

In accordance with various embodiments disclosed herein, beamforming and beam steering can be utilized to direct signals from individual antennas over a desired area or Field-of-View (FoV). For a radar system, this means the area within which the radar can detect objects, or targets. In vehicular applications, the FoV is often limited to an area in the path of the vehicle anticipating the movement of the vehicle. This is the case for automotive, trains, subways, airplanes, unmanned aerial vehicles, drones, and so forth. The ability to expand the FoV to include areas in non-line of sight of the vehicle can provide improved operation and safety.

The subject technology of some embodiments incorporates a Silicon Germanium (SiGe) based multi-channel beamformer (e.g., 4-16 channels) integrated circuit for transmitter and receiver operations. The subject technology allows a multitude of applications to achieve non-line of sight object detection in vehicular applications. The subject technology achieves substantial reduction in area, cost, printed circuit board complexity, and assembly. The subject technology reduces power consumption compared to traditional front-end circuits. The subject technology achieves higher functionality and higher reliability (including higher yield and larger integration capability). The subject technology facilitates integration with digital calibration and serial interfaces, analog and digital converters, various sensors and bias control. The subject technology also lowers packaging parasitic effects and reduces cost with the flip-chip implementation.

In the following examples and descriptions, a non-line of sight (NLOS) module is positioned within an environment, and may be a repeater, reflector or other device that provides visibility into the NLOS area of a vehicle. In various embodiments, the NLOS module is positioned at a point of discontinuity in a line of sight for a vehicle. In various embodiments, the NLOS module acts as an extension of a radar module on a vehicle, enabling visibility into NLOS areas.

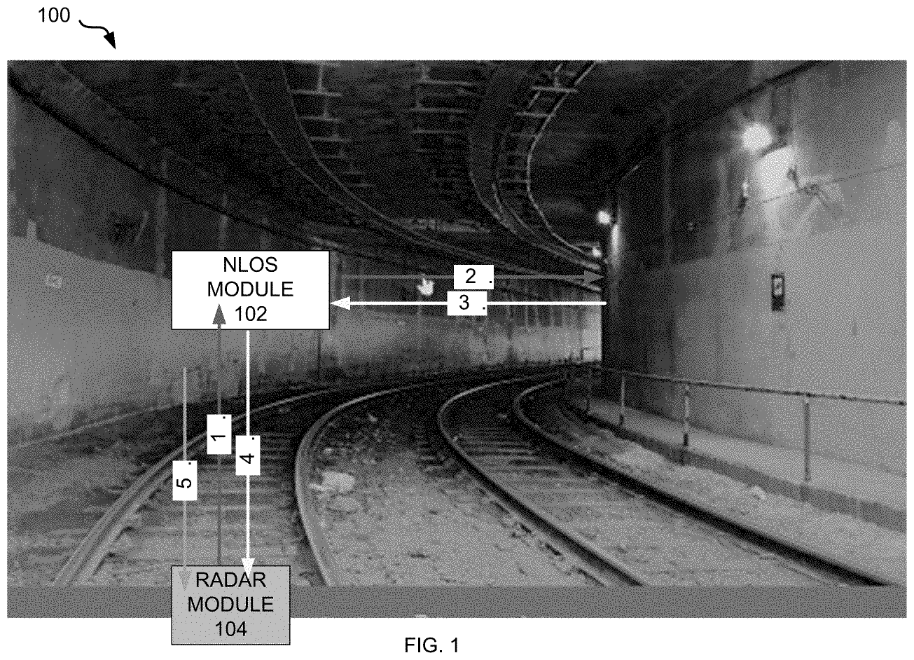

FIG. 1 illustrates a vehicle environment 100, such as in a tunnel with train tracks running through and having a curved portion as illustrated. A radar module 104 is positioned on a vehicle (not shown) configured to transmit modulated radar signals to detect objects in the environment 100. Positioned within environment 100 is an NLOS module 102 at a point in the curve ahead of the moving vehicle. In this example, the NLOS module 102 is a repeater that receives radar signals from radar module 104 on vehicle's approach towards the location of the NLOS module 102. The NLOS module 102 operates in response to an incident signal from radar module 104 by redirecting the received signal into a NLOS area. In various embodiments, the NLOS module 102 may be configured amplify the received signal. In various implementations, the radar signal is a modulated signal, such as a Frequency Modulated Continuous Wave (FMCW) signal enabling the radar module 104 to develop a range Doppler (RD) understanding or mapping of detected objects. The use of NLOS module 102 allows the radar module 104 to detect objects in the NLOS area and in some embodiments determine a location and movement of an object therein. In accordance with various implementations, the NLOS module 102 may be configured to phase shift the modulated radar signal. Signals received at the NLOS module 102 from the NLOS area and/or repeater direction are transmitted to the radar module 104. In various implementations, the NLOS module 102 includes phase shifters and amplifiers and may change the phase and gain of the signal for transmission. In various embodiments, the NLOS module 102 is configured to receive and transmit in multiple directions, so that the NLOS module 102 both receives signals from and transmits signals to the radar module 104. Similarly, the NLOS module 102 both transmits signals to the repeater direction and receives signals from objects detected in the repeater direction.

In various implementations, any number of radar modules may be implemented in a vehicle, such as an automotive, trains, subways, airplanes, unmanned aerial vehicles, drones, and so forth. In some embodiments, a single unit of the radar system may be used to cover a specific area. In various implementations, the radar system can be configured to scan a Field of View (FoV) or specific area. The radar signal is transmitted according to a set of scan parameters that can be adjusted to result in multiple transmission beams. The radar module 104 transmits signals modulated according to an FMCW. The transmit and receive signals are compared by the radar module 104, wherein a change in the frequency provides information about targets (e.g., detected objects). In some implementations, a time of flight (ToF) of the radar system provides information related to a range (e.g., range of distance) and the frequency change provides information as to speed/velocity of moving targets.

In various implementations, a radar system employing FMCW signals can be configured to transmit a sinusoidal signal at linearly increasing frequencies to generate a sawtooth wave when plotted as frequency over time. In some embodiments, one cycle of the signal can be referred to as a chirp. Each chirp has a start frequency, a bandwidth, and a duration. The slope of the chirp defines the ramp rate of the signal. Other examples may use alternate modulation techniques and may incorporate different waveforms for the transmit signal. The scan parameters of radar module 104 may include, among others, the total angle of the scanned area defining the FoV, the beam width or the scan angle of each incremental transmission beam, the number of chirps in the radar signal, the chirp time, the chirp segment time, the chirp slope, and so on. The entire FoV or a portion of it can be scanned by a compilation of such transmission beams, which may be in successive adjacent scan positions or in a specific or random order. Note that the term FoV is used herein in reference to the radar transmissions and does not imply an optical FoV with unobstructed views. The scan parameters may also indicate the time interval between these incremental transmission beams, as well as start and stop angle positions for a full or partial scan.

The radar module 104 transmits the FMCW signal, Tx; the transmitted signal, Tx, reflects off an object, referred to as a target, and the reflected signal or received signal, Rx, returns to the radar module 104. Comparison of Tx and the corresponding Rx provides target information about the physical distance from the radar module 10 to the target; this distance is referred to as the range. Various calculations of the target information provide more detailed information of the target. This information is used to identify the detected object, such as a person or vehicle, and parameters associated with the detected object. As the Rx signal is a delayed version of the Tx signal, the Rx signal and the Tx signal are mixed to form an instantaneous frequency (IF) which is the difference in the frequencies of the two signals. Range resolution refers to the ability of the radar module to resolve two closely spaced objects. In a given system if the objects are too close together, they will appear as a single peak in the frequency spectrum. To distinguish the objects, the system is designed to increase the length of the IF signal, which increases proportionally with bandwidth. The greater the bandwidth, the greater the resolution will be in a system.

In the present examples, the NLOS module 102 operates in coordination with the radar module 104 and other radar modules of other vehicles. Together it is possible to identify a location of target or objects in the path of a vehicle. Consider transmissions, Tx, from radar module 104 at frequency f₁. When Tx is received at NLOS module 102 the signal is redirected but the frequency is not changed. Reflections from objects in the NLOS direction are received at NLOS module 102, which then directs these to radar module 104. The Rx signal returns to radar module 104 from which the target information is determined. The radar module 104 may determine by the TOF that there is an object detected in the NLOS area. This information may be used to adjust a speed of the vehicle. If the NLOS module 102 determines that the object is in motion, the NLOS module 102 has phase shifting capability to change the frequency of the signal sent to the radar module 104, wherein the frequency shift identifies there is an object in motion.

In FIG. 1, the radar module 104 transmission is identified by the 1 arrow and is received at the NLOS module 102, which redirects the signal as the 2 arrow in a NLOS direction or a NLOS area. The redirected transmission detects an object, which results in a reflection from the object to the NLOS module 102, as indicated by the 3 arrow. In response to the receipt of the 3 arrow, the NLOS module introduces a frequency shift to the reflection and redirects the frequency shifted reflection to radar module 104, as indicated by the 4 arrow. The NLOS module 102 introduces a frequency shift evidenced as a Doppler shift, wherein the frequency shift is a value indicating that the reflection is not a direct reflection, such as the 5 arrow from an object to the radar module 104, but rather is from a NLOS module 102 and corresponds to an object in the NLOS area.

The NLOS module 102 may be referred to as a landmark having a known location. The location may be indicated by the specific frequency shift applied by the NLOS module 102 or may be stored in a library of the radar module 104. In some embodiments, the identify and therefore location of the NLOS module 102 is broadcast by a communication or messaging channel. There are a variety of methods for self-identification of the NLOS module 102. The NLOS module 102 acting as a landmark may be used to determine a speed of the vehicle, to identify the location of the vehicle and to detect objects in a path of the vehicle.

The NLOS module 102 shifts the frequency of returned signals to radar module 104 by phase shifting return signals. This results in a change in the Doppler frequency measured and calculated at the radar module of the system. As used in radar, the Doppler effect is the apparent change in frequency when a navigation target moves toward or away from the radar transmitter. The apparent change in the frequency between the source and receiver is due to the relative motion between the source and receiver. This is may be used to determine a speed and/or velocity of a detected target by a radar module. In the present system, the change in frequency is introduced by the navigation target, or receiver, as an identifier. The location of the navigation target is thus determined by the range to that target, the angle of arrival and so forth.

In some embodiments the NLOS module 102 is a repeater module configured to amplify signals for transmission, redirect transmission beams, apply phase shift to generate transmission signals at different frequencies, and may include a communication module. In some embodiments the repeater includes radar capability to compare transmit to receive signals and measure range and Doppler frequency shift.

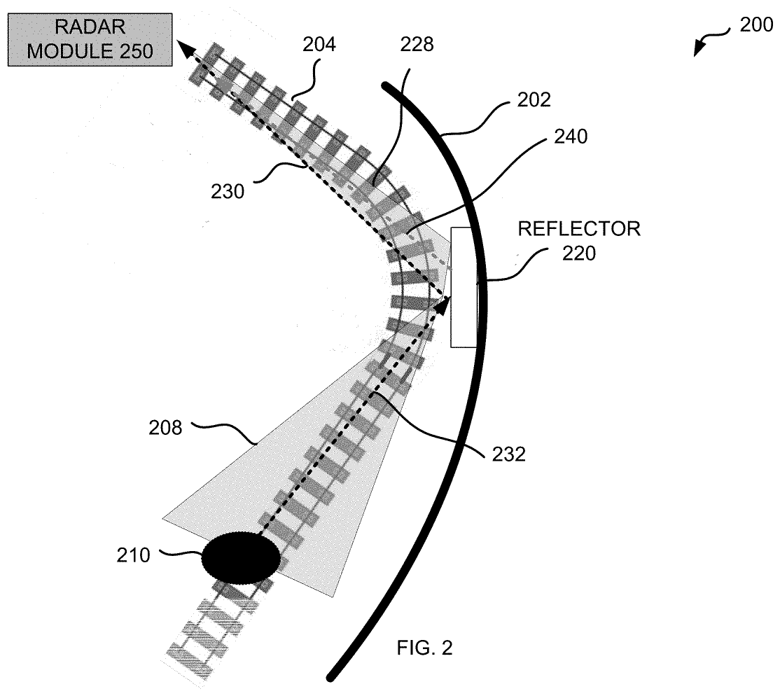

In the example environment 200 of FIG. 2, a train track 204 has a curved portion that runs through a tunnel 202. FIG. 2 illustrates a NLOS module 220 within environment 200 is a passive reflector module designed to receive signals at a first angle of arrival, such as a narrow beam from a radar module 250 on a vehicle, and reflect or redirect the incident signal or wave toward a NLOS area that may contain a target object 210. As illustrated in FIG. 2, the incident wave 228 is transmitted by the radar module 250 and then reflected as reflection wave 208 from the target object 210. As illustrated, the reflection wave 208 has a wider beam width than the incident wave 228, enabling the NLOS module 220 to monitor a large area while responding to specific signals from the radar module 250. Compared to the beam widths of the waves 228 and 208, lines 230 and 232 indicate the path of the incident signal and the reflected signal, respectively. The NLOS module 220 may be a frequency selective surface (FSS) responding to specific radar frequencies, such as 77 GHz or other frequencies, in the directions of the incident beam 228 and/or the reflected beam 208. Other signals incident on the NLOS module 220 or signals at other frequencies may reflect back at the angle of arrival, such as illustrated by return path 240.

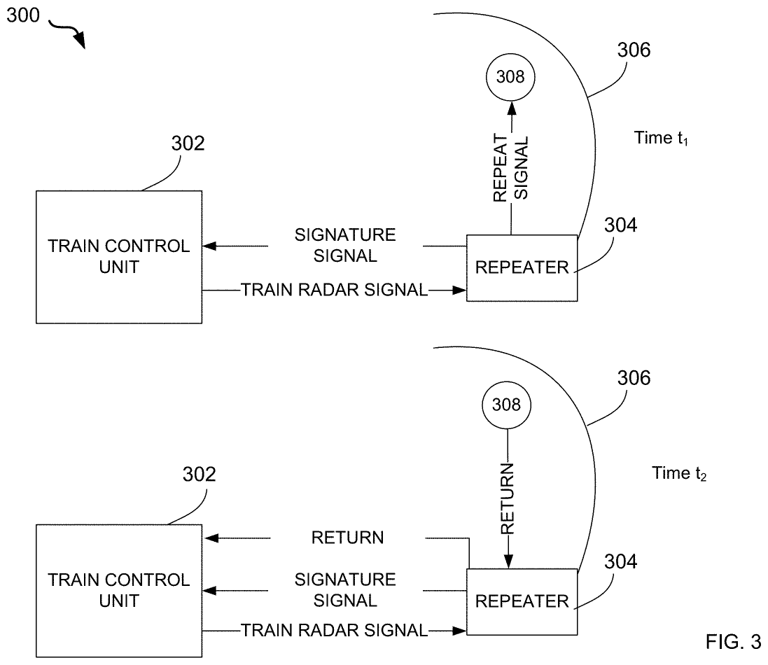

FIG. 3 illustrates signal flow in a radar repeater system, in accordance with one or more implementations of the subject technology. The train control unit 302 is designed for detection of objects in the tracks. Transmission signals are sent from the train control unit 302 into environment 300; however, the path of the train on the tracks goes through NLOS areas that are not visible to the train. Here visibility refers to the ability for sensors of the train control unit 302 to measure. For example, the NLOS area is not visible to the radar sensor/system of the train control unit 302 at a distance that would allow the train sufficient time to react, such as to slow down for an obstacle in the tracks. The train's response in curved tracks may be different than a response and control when the tracks are substantially straight. For example, the train control unit 302 sends a transmission, train radar signal, to repeater 304. At time t₁, the repeater 304 redirects the signal, repeat signal, to the NLOS area at curve 306. The curve 306 in the present environment 300 is within a tunnel. In this example the repeater 304 is stationary and positioned along a side of the tracks. An obstacle 308 reflects the repeat signal back to repeater 304 as a return signal as shown at time t₂, a return signal from the object is received at the repeater 304, which is redirected to train control unit 302. The repeater 304 receives the return signal and redirects to train control unit 302. The redirection is based on the angle of arrival of the train radar signal. In some embodiments, the repeater also sends a signature signal at time t₁, t₂ or both. The signature signal identifies the repeater, which may be to identify the capabilities of the repeater, the location of the repeater, or provide other information for train control unit 302 to extract parameters, measurements, locations and other information related to detected objects from signals received from repeater 304. The signature identifies signals received from repeater 304 and distinguishes these from direct reflections, such as from objects directly within the FoV of the train. In some embodiments, the repeater signature is contained in the return signal, such as to change the frequency of the return signal to a value exceeding a Doppler frequency shift threshold.

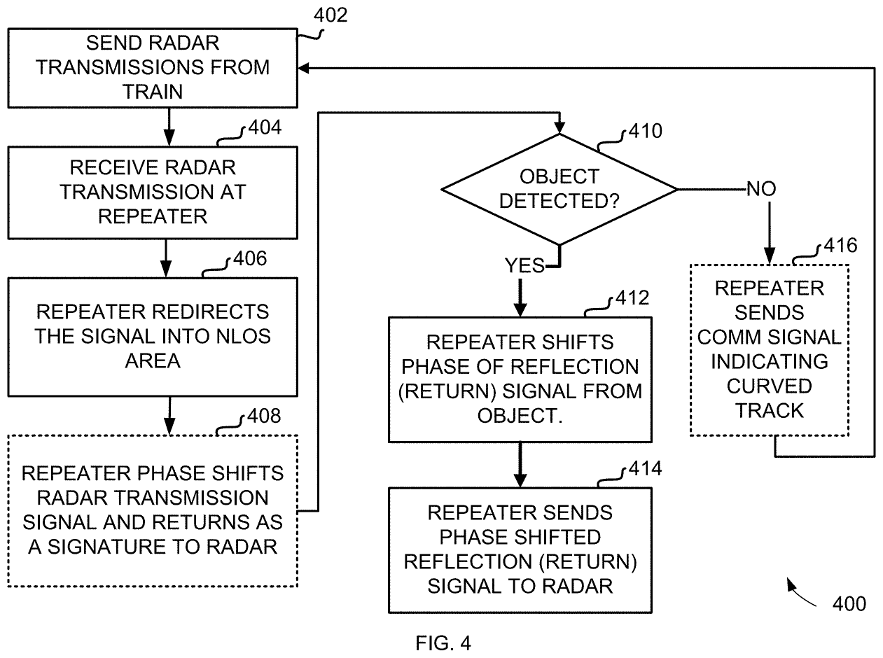

FIG. 4 illustrates a flow diagram of operation 400 of a radar repeater system in accordance with one or more implementations of the subject technology. Radar transmissions are sent from a train or other vehicle, 402. The repeater receives the radar transmissions, 404 and redirects the radar transmission signal into a NLOS area, 406. Optionally, the repeater may introduce a phase shift to the radar transmission signal and return the phase shifted signal to the radar unit, 408. If an object is detected in the NLOS area, 410, the repeater receives the return signal and introduces a phase shift into the return signal from the object, 412. The repeater then directs the phase shifted return signal to the radar, 414. If no object is detected, 410, the repeater continues to receive radar transmission signals. Optionally, the repeater may send communication signal indicating a curved track ahead, 416. The radar unit continues to send radar transmission signals, 402.

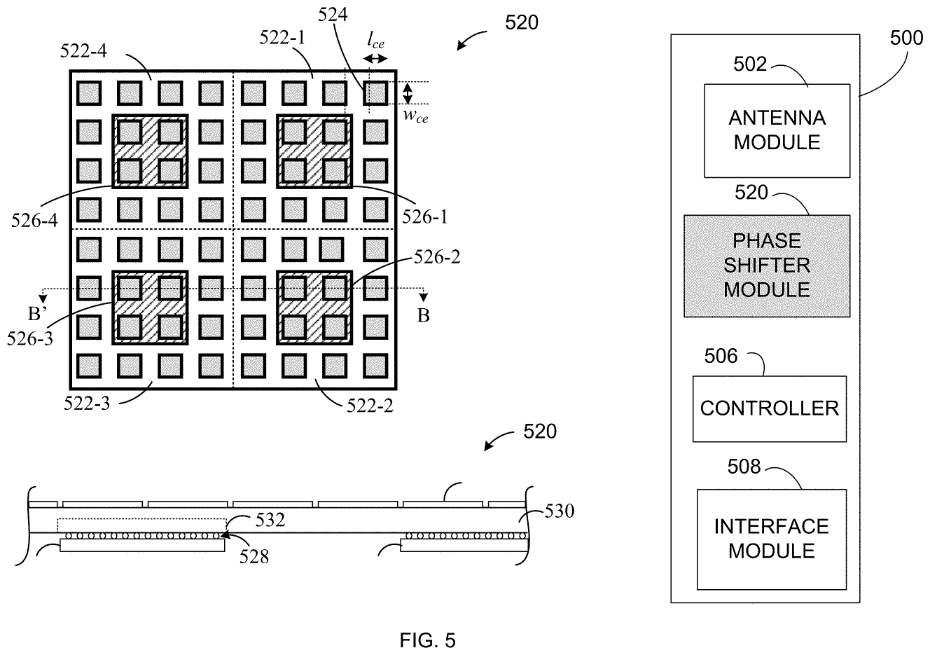

FIG. 5 illustrates a portion of a repeater 500, having a phase shifter module 520 that is configured between an antenna module 502, a controller 506, and an interface module 508. As illustrated in FIG. 5, antenna module 502 has receive and transmit capabilities, which may use a single antenna, separate receive and transmit antennas, and so forth. A receive antenna of the antenna module 502 may be configured to receive a radar transmission or radar signal. A transmit antenna of the antenna module 502 may be configured to transmit a return radar transmission or a response (radar) signal. The phase shifter module 520 may be coupled between the receive antenna and the transmit antenna of the antenna module 502. In operation, the receive antenna receives a radar signal and sends the signal to the phase shifter module 520. The phase shifter module 520 can be configured to adjust or phase shift the frequency in response and transmits the shifted radar signal in a radar transmission to the transmit antenna for transmitting the response signal comprising the phase shifted signal.

In the illustrated example of the repeater 500, the phase shifter module 520 can be a beamformer integrated circuit package tile (also referred to herein as “beamformer integrated tile”). The beamformer integrated circuit package tile 520 includes antenna elements 524 and Radio Frequency Integrated Circuits (RFICs) 526-1, 526-2, 526-3, 526-4. In some implementations, the beamformer integrated circuit package tile 520 includes 64 antenna elements per tile, such that the tile includes a number of channels that corresponds to the number of antenna elements. In various implementations, each tile may be configured as a transmitter (TX) tile or a receiver (RX) tile, where the tile as a transmitter tile includes 64 TX channels or as a receiver tile that includes 64 RX channels. However, the number of antenna elements may be arbitrary and vary depending on implementation. In some implementations, the beamformer integrated circuit package tile 520 includes four (4) 16 channel beamforming ICs (e.g., RFICs 526-1, 526-2, 526-3, 526-4) per tile (based on a 64-element tile), but the number of channels per beamforming IC can vary depending on implementation. The antenna elements 524 may be mounted to a first surface of the beamformer integrated circuit package tile 520 and the RFICs 526-1, 526-2, 526-3, 526-4 may be mounted to a second surface (opposite to the first surface) of the beamformer integrated circuit package tile 520.

The beamformer integrated circuit package tile 520 may be formed of a specific fabrication technology that allows for high interconnect density, compact routing networks and high frequency applications, such as millimeter wave applications. The beamformer integrated circuit package tile 520 may be an organic packaging-based tile with high precision PCB manufacturing. In some implementations, the beamformer integrated circuit package tile 520 is formed with a Low-Temperature Co-fired Ceramic (LTCC) substrate or package. In other implementations, the beamformer integrated circuit package tile 400 is formed with a Flip-Chip Ball Grid Array (FCBGA) package.

In some implementations, the RFICs 526-1, 526-2, 526-3, 526-4 include phase shifters for providing RF signals at multiple steering angles. The RFICs 526-1, 526-2, 526-3, 526-4 may include a phase shifting control module for providing phase shifting to transmission lines while mitigating parasitic effects on the transmission lines. As depicted in FIG. 4, the RFICs 526-1, 526-2, 526-3, 526-4 are respectively located in regions 522-1, 522-2, 522-3, 524-4 of the beamformer integrated circuit package tile 400. Each of the regions 522-1, 522-2, 522-3, 524-4 includes a subset of the antenna elements 524, where each corresponding RFIC provides phase shifting to the transmission lines coupled to the corresponding antenna elements in that region. In some examples, the beamformer integrated circuit package tile 520 with a 64-element arrangement can produce horizontal and vertical beam-width of about 12.7 degrees.

In some implementations, each of the antenna elements 524 includes conductive printed elements, such as printed patches of different shapes. In some examples, the antenna elements 524 may be composed of microstrips, gaps, dipoles (e.g., parallel dipoles or cross dipoles), and so forth. The conductive printed elements may also have different configurations, such as a square patch, a rectangular patch, a dipole, multiple dipoles, and so on. Other shapes (e.g., trapezoid, hexagon, etc.) may also be designed to satisfy design criteria for a given millimeter wave application, such as the location of the beamformer integrated circuit package tile 400 relative to the roadway, the desired range and angular resolution performance, and so on. Various configurations, shapes, and dimensions may be used to implement specific designs and meet specific constraints.

As illustrated, beamformer integrated circuit package tile 520 is a rectangular active antenna array with a length l and a width w. For example, the beamformer integrated circuit package tile 520 includes the antenna element 524 that is a rectangular conductive printed patch with dimensions w_{ce} and i_{ce} for its width and length, respectively. The dimensions of the antenna element 524 may in the sub-wavelength range (˜λ/M), with λ indicating the wavelength of its operational RF signal and M being a positive integer. As described in more detail below, the design of the beamformer integrated circuit package tile 520 is driven by geometrical considerations for a given application. The dimensions, shape and cell configuration of the beamformer integrated circuit package tile 400 will therefore depend on the application.

The cross-sectional view of the beamformer integrated circuit package tile 520 is taken along the B-B′ axis. The beamformer integrated circuit package tile 520 includes a substrate 530 with the antenna elements patterned on a top surface of the substrate 530. The RFICs 526-2 and 526-3 are coupled to a bottom surface of the substrate 530 with conductive fasteners 528. In various implementations, the conductive fasteners 528 include solder balls, solder bumps, micro bumps, or the like, for fastening the RFICs 526-2 and 526-3 to the substrate 530 with soldered connections.

In some implementations, the substrate 530 includes a cavity 532 for receiving a RFIC package (e.g., RFIC 526-3) such that the RFIC package is coupled to an inner surface of the cavity 532. In various implementations, the RFIC package can be fastened to the inner surface of the cavity 532 through soldered connections. In other aspects, the cavity may be filled with a resin adhesive to bond the RFIC package to the substrate 530. In this respect, by having the RFIC package inside the cavity 532, the package height of the beamformer integrated circuit package tile 520 is reduced.

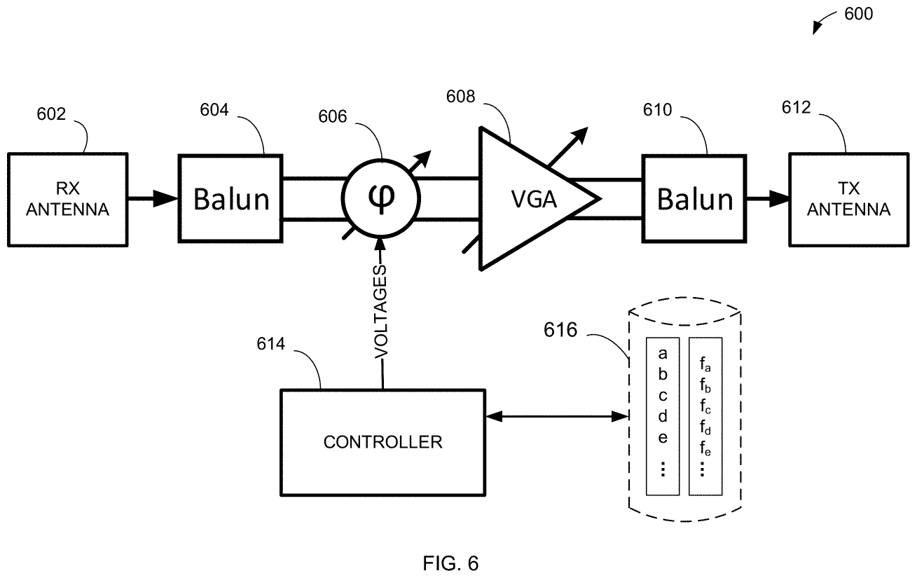

Now referring to FIG. 6, which illustrates a schematic diagram of a radar phased array system with a phase shifter module (also referred to herein as “phase shifting module”) 600 in accordance with one or more implementations of the subject technology. In various implementations, the phase shifter module 600 may be configured in a flip-chip format using SiGe technology. The phase shifter module 600 in the present embodiment is designed as a tile. The phase shifter component 606 is coupled between receive antenna 602 and transmit antenna 612. A variable gain amplifier, VGA is coupled on the transmit path. A controller 614 provides a bias voltage to the phase shifter component 606 to implement different phase shifts to signals processed through the phase shifter module 600. A repeater library 616 may be coupled to the controller 614 that maps bias voltages to frequencies, wherein the bias voltage implements a phase shift to achieve the frequency change. In some embodiments the phase shifter component 606 is fixed to provide a predetermined phase shift. As illustrated in FIG. 6, baluns 604 and 610 are positioned within the receive and transmit paths.

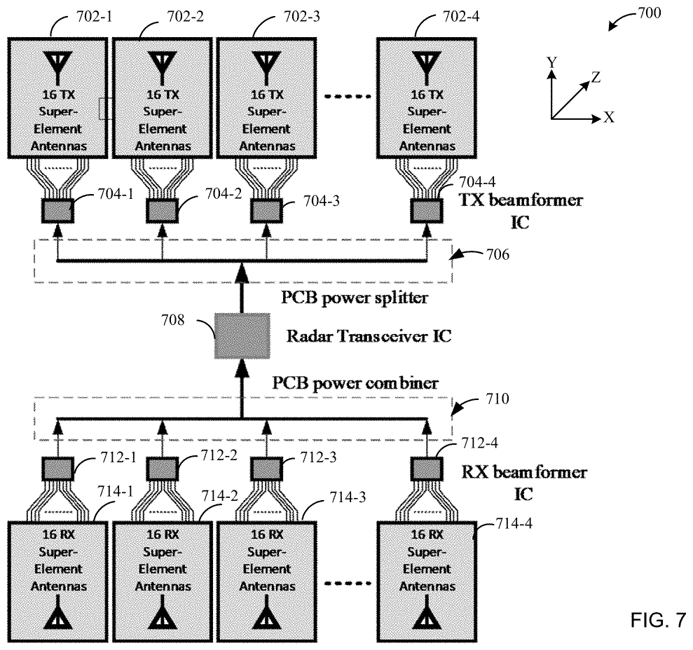

FIG. 7 is a schematic diagram of a tile array to implement a phase array system 700. The system 700 includes multiple super-element antennas configured as a set of transmitter antenna modules 702-1, 702-2, 702-3, and 702-4, transmit beamformer ICs 704-1, 704-2, 704-3 and 704-4, a power splitter 706, a radar transceiver IC 708, a power combiner 710, receiver antenna modules 714-1, 714-2, 714-3, and 714-4, receive beamformer ICs 712-1, 712-2, 712-3 and 712-4. Not all of the depicted components may be required, however, and one or more implementations may include additional components not shown in the figure. Variations in the arrangement and type of the components may be made without departing from the scope of the claims as set forth herein. Additional components, different components, or fewer components may be provided.

The transmitter antenna modules 702-1, 702-2, 702-3, and 702-4 are respectively coupled to the transmit beamformer ICs 704-1, 704-2, 704-3 and 704-4 through a multi-channel interface. In various implementations, each of the transmitter antenna modules 702-1, 702-2, 702-3, and 702-4 can include multiple antennas, such as 16 antennas. The transmit beamformer ICs 704-1, 704-2, 704-3 and 704-4 are coupled to the power splitter 706. In various implementations, the power splitter 706 includes a corporate feed network patterned on a Printed Circuit Board (PCB) for distributing a single source input into multiple output signals at respective power levels. The power splitter 706 is coupled to the radar transceiver IC 708. The radar transceiver IC 708 is coupled to the power combiner 710. In various implementations, the power combiner 710 includes a corporate feed network patterned on PCB for combining multiple input signals at respective power levels into a single destination output. The power combiner 710 is coupled to the receive beamformer ICs 712-1, 712-2, 712-3 and 712-4, which are. respectively coupled to the receiver antenna modules 714-1, 714-2, 714-3, and 714-4.

In some implementations, each of the transmitter antenna modules 702-1, 702-2, 702-3, and 702-4 includes a substrate (not shown) having multiple conductive layers and a dielectric layer sandwiched therebetween. In various examples, each of the transmitter antenna modules 702-1, 702-2, 702-3, and 702-4 is configured as super elements that are arranged along the x-direction of the 1D radar phased array system 500, in which each super element includes a plurality of slots or discontinuities in the conductive layer proximate antenna elements of the respective transmitter antenna. A signal is provided to each of the super elements that radiates through the slots in the super elements and feeds the antenna elements in the transmitter antenna. The various super elements may be fed with signals of different phase, thus providing phase shifting in the y-direction, while the respective transmitter antenna may be controlled so as to shift the phase of the transmission signal in the y-direction and/or the x-direction, while the signal transmits in the z-direction.

Like the transmitter antenna modules 702-1, 702-2, 702-3, and 702-4, each of the receiver antenna modules 714-1, 714-2, 714-3, and 714-4 includes a substrate (not shown) having multiple conductive layers and a dielectric layer sandwiched therebetween. In various examples, each of the receiver antenna modules 714-1, 714-2, 714-3, and 714-4 is configured as super elements that are arranged along the x-direction of the 1D radar phased array system 500, in which each super element includes a plurality of slots or discontinuities in the conductive layer proximate antenna elements of the respective receiver antenna. A signal is received at the antenna elements in the receiver antenna, which is then provided to each of the super elements that radiates through the slots in the super elements and feeds the receive beamformer ICs 712-1, 712-2, 712-3 and 712-4 for phase shifting the incoming RF signaling.

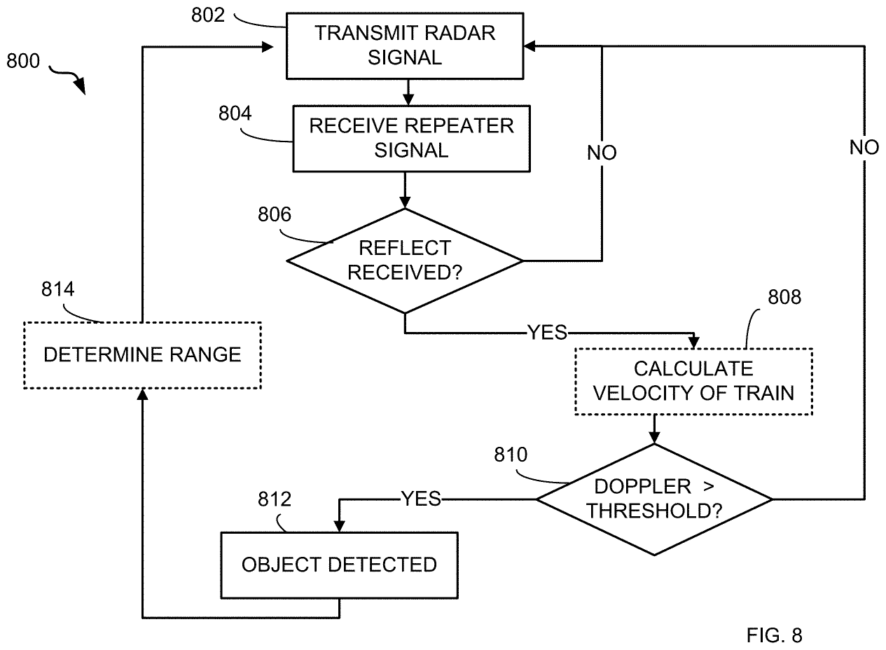

FIG. 8 illustrates operation of a radar module in coordination with a NLOS module. The process 800 transmits radar signals, 802. The radar module receives the repeater signal, 804, which may include a signature for the repeater. When the radar module determines that a reflect signal is received, a Doppler shift is compared to a threshold, 810. Optionally, the process may calculate a speed or velocity of the train or vehicle, 810, that houses the radar module. If the Doppler shift is greater than the threshold value, an object is detected, 812 in the NLOS area visible to the repeater. Optionally, the radar module may determine the range or location of the detected object, 814.

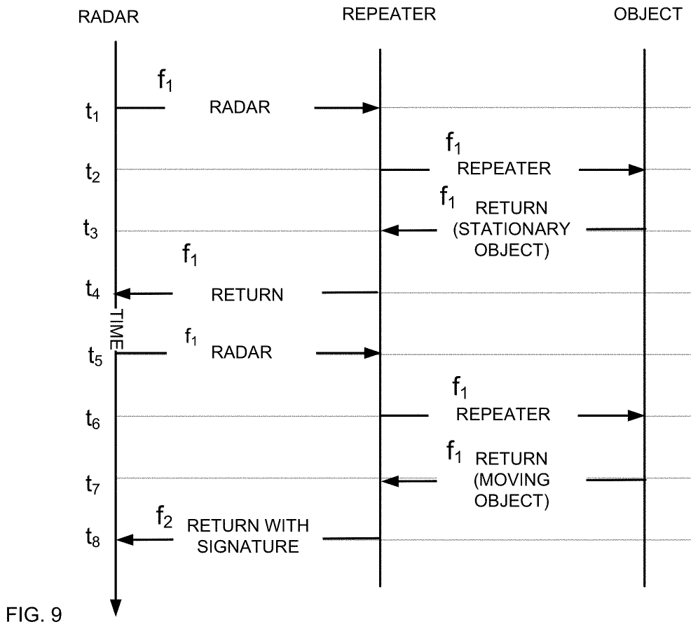

FIG. 9 is a signal flow diagram similar to the operation of FIG. 8. At time t₁, a radar signal transmission goes out at frequency f₁. At time t₂, the repeater redirects the radar signal transmission to a NLOS area at frequency f₁. At time t₄, an object is detected and a reflection or return signal from the object returns to the repeater at frequency f₁. This object is stationary. At time t₄, the repeater transmits the return signal to the radar module at frequency f₁. The radar module determines the range to the repeater by direct returns from direct radar returns. Using the ToF for the return signal at time t₅, the radar module is able to determine an approximate location of the object and adjust control of the train accordingly. In this scenario, the repeater does not apply a phase shift to the signals passing through the repeater. At time t₆, a radar signal transmission goes out at frequency f₁ and is received at the repeater, which transmits the radar signal transmission into a NLOS area at time t₆. At time t₇, a return signal reflects off a moving object and returns to the repeater at frequency f₁. The repeater applies a phase shift to the return signal to identify that this is a moving object, wherein the phase shift is a signature for the repeater. In some embodiments, the repeater does not apply a signature, but rather the radar module relies on the range to the repeater to determine an approximate location of an object. The signature of the repeater may be used for a variety of purposes in addition to the examples presented herein, such as to identify a specific repeater having a GPS location stored in a repeater library in a radar module. The signature may be used to identify that a return signal is not direct but rather is through a repeater and therefore the ToF does not correspond to a linear range. In other embodiments, the signature may have multiple values, each indicating a different parameter of the environment, such as distance from the repeater to the curve of a track, or other characteristic of the area that may assist in regulation of a train.

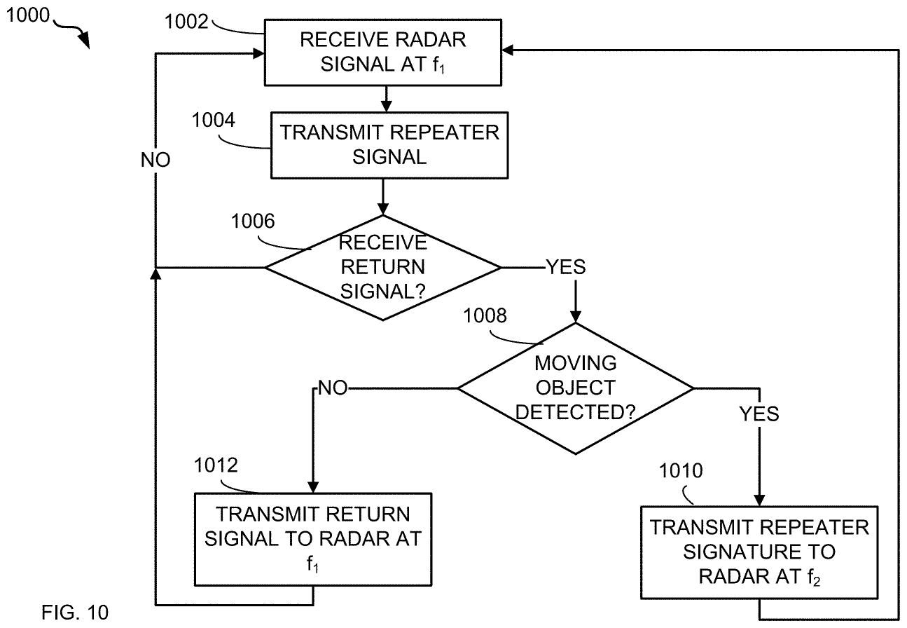

FIG. 10 is a process for operation of a repeater, similar to that illustrated in signal flow diagram of FIG. 9. The repeater receives a radar signal at a first frequency, 1002. The signal is transmitted from the repeater toward a NLOS area, 1004. When a return signal is received, 1006, processing continues to determine if the detected object is moving, 1008. This may be done in a manner similar to that of a radar module by comparing a transmit signal from the repeater to the return signal. If the object is moving, the repeater applies a phase shift to the return signal and redirects the shifted signal to radar at a corresponding second frequency, 1010. If the object is not moving, the repeater transmits a return signal to the radar unit at a first frequency, 1012.

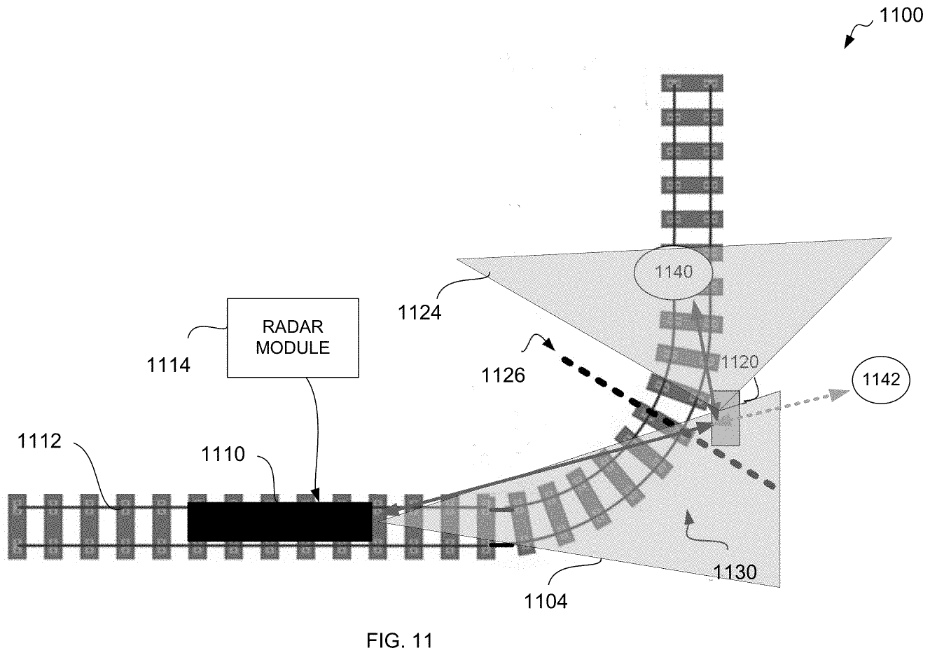

Other NLOS modules may incorporate a passive device, such as a reflector 1120 of FIG. 11. The reflector is positioned in a tunnel starting as identified by the line 1126; the reflector 1120 is positioned to reflect incident signals into a NLOS area 1124. A train 1110 moving along the tracks 1112 includes a radar module 1114 having a beam width 1104. When the beam is directed to reach the reflector 1120, signals are reflected into NLOS area covered by beam width 1124. The reflector 1120 is designed to receive a radar signals and reflect them into the NLOS area. When an object 1140 is detected and reflects signals back to the reflector 1120, signals are then returned to the radar module as indicated by the arrows. By measuring ToF, the radar module 1114 determines that a direct reflection corresponds to an object at position 1142, however, the reflector 1120 increases the gain of the return signal to the radar module 1114 and the radar module 1114 is able to identify the object is actually in a NLOS area with reflection from reflector 1120.

In the radar reflector system 1100 implementing the subject technology, wherein a train 1110 on train tracks 1112 travelling toward a curve 1130. The radar module 1114 operates at a given frequency, such a 77 GHz. The reflector module 1120 is positioned near the curve 1130, which is a situation that impacts operation of train 1110. The reflector 1120 is positioned to direct incident waves into a NLOS area of the train 1110. The reflector 1120 is this example is a passive device made up of unit cells configured to reflect incident waves in a given direction. The incident waves may come from the train 1110 or from objects in the NLOS area. The reflector is as described in FIG. 2. Objects detected by the reflector 1120 such as object 1140 are visible to the radar module 1114. The transmission signal from radar module 1114 has a beam width 1124. Reflector 1120 will reflect signals received from radar module 1114 into the NLOS area of beam width 1124. The beam width 1124 and reflector 1120 may be designed having different dimensions and various unit cells. Unit cells are typically non-uniform and asymmetric to achieve a reflection characteristic and behavior. The reflector 1120 may receive a narrow radar transmission and reflect this signal as a wide reflection. In the present example, the reflection beam returns from object 1140 and is then reflected or redirected back to the radar module 1124. As part of radar operation, the radar module 1114 compares radar transmissions signals to received signals to evaluate ToF, angle of arrival, and phase shift. The ToF for a reflection from NLOS area where object 1140 is located will be approximately the same as if there were an object 1142 directly ahead of the train. The radar module 1114 distinguishes object 1140 from an object 1142 by the gain of the return signal. A direct reflection from radar module 1114 to an object returns at a lower gain than transmitted due to transmission losses. The reflector 1120 is designed to increase the gain of the incident signals. In the present embodiment, the reflector 1120 is a reflectarray made up of an array of unit cells.

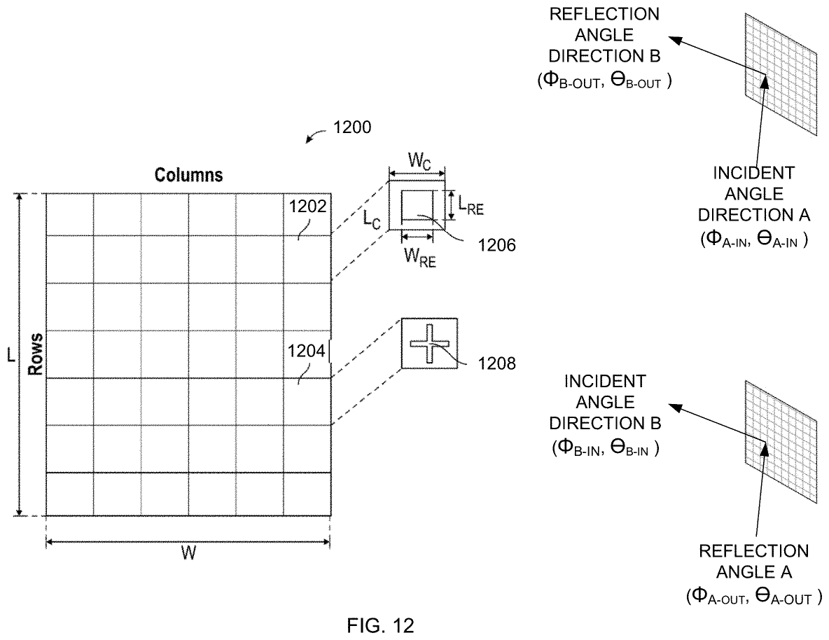

FIG. 12 illustrates a reflectarray antenna according to an example embodiment. As described herein, a reflectarray can serve as a passive relay or active relay between a radar module and a NLOS area enhancing the visibility of the radar. The reflectarray antenna 1200 receives a signal at an incident angle (or direction) and reflects the signal into one or more directional beams aimed for a NLOS area. The reflectarray 1200 behaves as a two-way reflector, whereby an incident wave from a first direction reflects in a second direction and an incident wave from the second direction reflects in the first direction. The directivity of the reflectarray 1200 is achieved by considering the geometrical configurations of the environment, which in the present embodiments is a curved train track. Various configurations, shapes, and dimensions may be used to implement specific designs and meet specific coverage area constraints. The reflectarray 1200 is designed to achieve the specific reflection and returns desired. The reflectarray 1200 as disclosed herein may result in a significant performance improvement by increasing the gain of reflected signals. The reflectarray 1200 is a low cost, easy to manufacture and set up reflectarray, and may be self-calibrated without requiring manual adjustment.

The reflectarray 1200 has various cell configurations in accordance to various implementations of the subject technology. The reflectarray 1200 includes an array of cells organized in rows and columns. The reflectarray 1200 may be passive or active. A passive reflectarray may not include any active circuitry or other controls, as once in position it passively redirects incident beams into a specific focused direction. The reflectarray 1200 provides directivity and high bandwidth and gain due to the size and configuration of its individual cells and the individual conductive printed elements within those cells.

In various examples, the cells in the reflectarray 1200 include conductive printed patches of different shapes. In other examples, the reflectarray cells may be composed of microstrips, gaps, patches, dipoles, and so forth. Various configurations, shapes, and dimensions may be used to implement specific designs and meet specific constraints. As illustrated, reflectarray 1200 is a rectangular reflectarray with a length 1 and a width w. In other examples, the reflectarray 1200 may be circular with a radius r. Each cell in the reflectarray 1200 has a conductive printed element. The conductive printed elements may also have different configurations, such as a square patch, a rectangular patch, a dipole, multiple dipoles, and so on. Other shapes (e.g., trapezoid, hexagon, etc.) may also be designed to satisfy design criteria for a given application, such as the location of the reflectarray 1200 relative to the train path, the desired gain and directivity performance, and so on.

For example, the reflectarray 1200 includes a cell 1202 that is a rectangular cell with dimensions w_{c} and l_{c} for its width and length, respectively. The cell 1202 includes a conductive printed element 1206 with dimensions wᵣₑ and lᵣₑ. The dimensions of the conductive printed element are in the sub-wavelength range (λ/3) with λ indicating the wavelength of its incident or reflected F signals. In other examples, the reflectarray 1200 includes a cell 1204 that has a cross-dipole element 1208. As described in more detail below, the design of the reflectarray 1200 is driven by geometrical considerations for a given application or deployment, whether indoors or outdoors. The dimensions, shape and cell configuration of the reflectarray 1200 will therefore depend on the particular application.

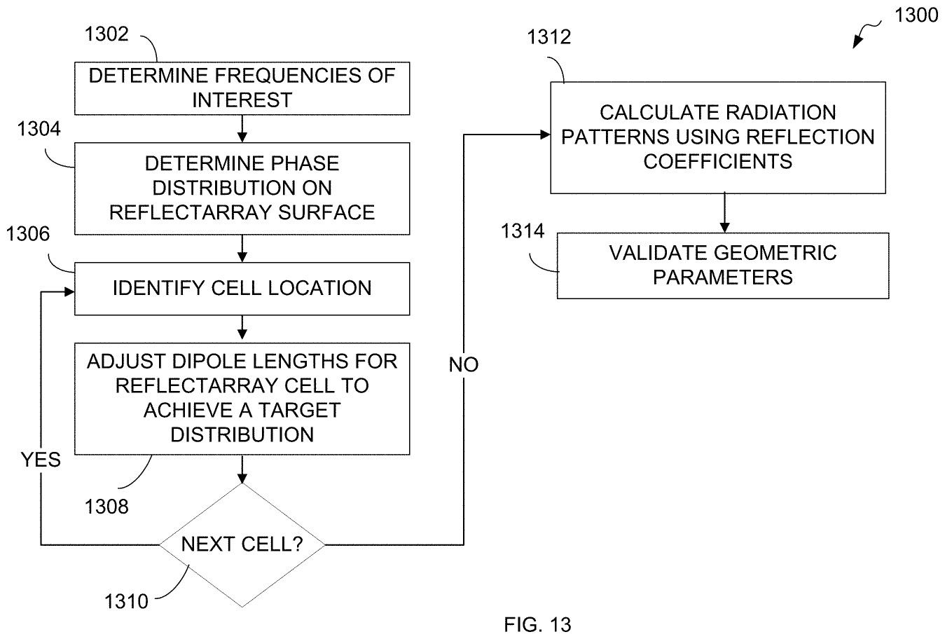

FIG. 13 illustrates a flowchart of an example process 300 of designing a reflectarray for enhanced wireless communication coverage area, in accordance with various implementations of the subject technology. For explanatory purposes, the blocks of the example process 1300 are described herein as occurring in serial, or linearly. However, multiple blocks of the example process 1300 may occur in parallel. In addition, the blocks of the example process 1300 may be performed in a different order than the order shown and/or one or more of the blocks of the example process 1300 are not performed.

The process 1300 begins by determining frequencies of interest and dimensions of the reflective area, including NLOS area and environment, 1302. The process determines a phase distribution on a reflectarray surface, 1304. Once the cell location is identified, 1306, the process adjusts dipole lengths for the current reflectarray cell to achieve a target distribution, 1308. This process continues until there are no unadjusted cells, 1310, and calculates the radiation patterns using reflection coefficients, 1312. The process then validates the geometric parameters, 1314.

As discussed herein, in some embodiments, design of a reflectarray antenna involves various cell configurations in accordance to various implementations of the subject technology. This involves performing phase-only pattern synthesis to optimize reflectarray design for operation over a range of frequencies, band widths, incident angles and corresponding reflection angles. The reflectarray may include an array of cells organized in rows and columns which are organized according to whether the reflectarray is passive or includes active components. A passive reflectarray may not include any active circuitry or other controls, as once in position it passively redirects incident beams into a specific focused direction. Therefore, the passive reflectarray is designed to operate without any assistance from electronics while providing directivity, high bandwidth and increased gain due to the size and configuration of its individual cells and the individual conductive printed elements within those cells.

The example process 1300 illustrated in FIG. 13 may be performed in a variety of ways and include details to enhance the process. In some embodiments, a phase-only pattern synthesis is performed in an electronic system, such as by software configured for these steps and evaluations. For clarity, the portions, stages, referred to as blocks, procedures or steps, of the design process are described herein as occurring in series, or linearly. However, multiple stages of the design process may occur in parallel. In addition, the stages of the example process may be performed in a different order than the order shown and/or one or more of the stages of the process may be omitted or not performed.

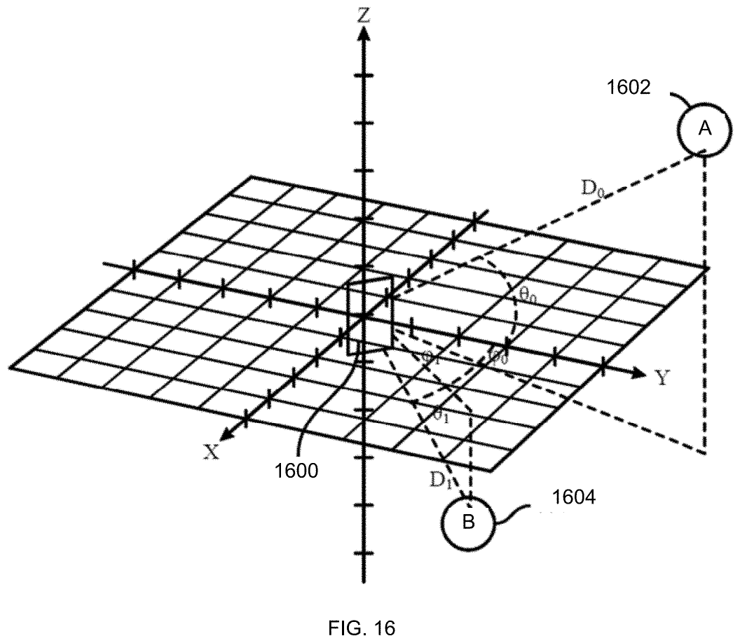

Continuing with a detailed example embodiment and application of the process 1300, a coverage area is determined based at least on the feed location. This step involves determining the geometry setup of the train tracks relative to the placement of the reflectarray. The geometry setup considers the path of train tracks, the location of a NLOS area for a train travelling on the train tracks, the positions of the train proximate the NLOS area, the beam characteristics of the train's radar module, the range and velocity measuring capabilities of the radar module, and so forth. This information is used to determine the orientation and position of the reflectarray antenna itself. Parameter measures and angles are illustrated in FIG. 16 in further detail for the geometry setup of reflectarray 1600 between two locations, location A 1602 and location B 1604. Location A is identified at distance D0 from reflectarray 1600 in a Cartesian (x, y, z) coordinate system where reflectarray 1600 is positioned in the center of the coordinate system. The reflectarray antenna 1600 has a relative boresight in this position along the y-axis. The location A 1602 has an elevation angle θ₀ and an azimuth angle φ₀. Determining the geometry setup involves application of geometrical tools at the site, or may be done remotely by computer simulation. Physical measurements may be done such as using a laser distance measurer and an angles measurer. This highlights that some embodiments will have a simplified setup, which incentivizes use for enhanced radar coverage and performance at low cost with a highly manufacturable reflectarray structures that may be deployed in a variety of locations and for various applications. The reflectarray 1600 be used to reflect incident RF waves from location A 1602 at a distance D₁ from the reflectarray antenna 1600 with θ₁ elevation and φ₁ azimuth angles toward location B 1604, which represents the NLOS area.

Continuing with a process as in FIG. 13, a tangential reflected field on a reflectarray surface is calculated based at least on the feed location and initial geometric parameters of the reflectarray surface. The pattern synthesis of the subject technology is an iterative algorithm that performs two operations at each iteration, i, on the tangential reflected field, so the working principle of the algorithm can be described as:

\vec{E}_{ref,i+1}= [symbol] [ [symbol] (\vec{E}_{ref,i})] Eq. (1),

where [symbol] is the forward projector (which projects the radiated field by the antenna onto a set of fields that comply with the antenna specifications, [symbol] is the backward projector (which projects the field that complies with the antenna specifications onto the set of fields that can be radiated by the antenna, and \vec{E}_{ref} is the tangential reflected field on the reflectarray surface. Referring back to FIG. 4, the reflectarray antenna 404 is illuminated by the feed 402, generating an incident electric field on its surface. The tangential reflected field on the reflectarray surface at each reflectarray element can be expressed as:

E_{ref}^{X/Y}(xₗ,yₗ)=R^{l}·\vec{E}_{1nc}^{X/Y}(x₁,y₁), Eq. (2),

where R^{l} is the reflection coefficient matrix, (xₗ, yₗ) are the coordinates of the center of the reflectarray element l, \vec{E}_{1nc}^{X/Y}(xₗ, yₗ) is the fixed incident field impinging from the feed. The components of matrix R^{l} are complex numbers that fully characterize the electromagnetic behavior of the reflectarray cell. The reflection coefficient matrix takes the form:

$${R}^{l} = ( \begin{matrix}{ρ}_{xx}^{l} & {ρ}_{xy}^{l} \\ {ρ}_{yx}^{l} & {ρ}_{yy}^{l}\end{matrix} ) , , \qquad Eq . ( 3 )$$

where ρₓₓ^{l} and ρ_{yy}^{l} are known as direct coefficients, while ρ_{xy}^{l} and p_{yx}^{l} are known as the cross-coefficients. The co-polar pattern may depend on the direct coefficients, and the crosspolar pattern depends on all coefficients. In various implementations, the coefficients are computed with a full-wave analysis tool assuming local periodicity.

Subsequently, at step 706, the algorithm starts with the focus at the center of the reflectarray antenna, where about 20% of elements are being focused at center. This is because the center of the reflectarray antenna is the most illuminated by the feed.

As part of the radiation pattern optimization, radiation pattern specifications are imposed in the copolar and crosspolar components. When performing the pattern synthesis of the subject technology, only the copolar requirements are considered due to the simplification in the analysis of the reflectarray cell. In the IA algorithm, the copolar specifications are represented by two mask templates, namely the minimum (Tₘᵢₙ) and maximum (Tₘₐₓ) values, which are the minimum and maximum thresholds between which the copolar radiation pattern is expected to lie. In this respect, the copolar gain, G_{cp}, relative to the mask thresholds can be expressed as follows:

Tₘᵢₙ(u,v)≤G_{cp}(u,v)≤Tₘₐₓ(u,v) Eq. (4),

where u=sin θ cos φ and v=sin θ sin φ are the angular coordinates where the far filed is computed.

An initial phase distribution for the copolar reflection coefficients on the reflectarray surface is determined based at least on a defocused radiating beam pointed toward the coverage area at a predetermined elevation plane and a predetermined azimuth plane. As discussed above, the objective of the pattern synthesis is to obtain a phase shift distribution that generates the desired shaped radiation pattern. In this respect, the initial phase distribution for the pattern synthesis may be obtained analytically, which can be expressed as follows:

∠ρ(x₁,y₁)=k₀(d₁-d₀-(x₁ cos φ₀+y₁ sin φ₀)sin θ₀), Eq. (5),

where ∠ρ(x₁,y₁) is the phase of a direct reflection coefficient (ρₓₓ or ρ_{yy}, for linear polarizations X and Y, respectively), dₗ is the distance from the feed to the lth element (see 410 of FIG. 4), d₀ is the displacement of the feed that corresponds to the defocused beam (defocusing distance); and (φ₀, θ₀) is the pointing direction of the focused beam. In various implementations, the angle (φ₀, θ₀) is selected in a direction where the desired shaped beam has relatively high gain. In this respect, the defocused beam is pointed towards a direction that corresponds to the direction where a pencil beam has maximum gain.

For iterative pattern synthesis, an algorithm is performed on the initial phase distribution with a first target gain. In some implementations, each step of the iterative pattern synthesis algorithm includes performing the forward projection operation and the backward projection operation. In various implementations, the forward projection operation includes computing the radiation pattern of the far field, for both linear polarizations, and trimming the far field gain of the current gain radiated by the antenna. In some implementations, each step may perform a fixed number of iterations of the operations with the same parameters. In various implementations, the number of iterations performed may vary between steps, depending on implementation.

In some implementations, the reflectarray cell is modeled as an ideal phase shifter, where there are no losses (e.g., ρₓₓ^{l}=ρ_{yy}^{l}) and no element crosspolarization (e.g., ρ_{xy}^{l}=ρ_{yx}^{l}=0). Thus, the reflection coefficient matrix is simplified to:

$${R}^{l} = ( \begin{matrix}{e}^{( j {ϕ}_{xx}^{l} )} & 0 \\ 0 & {e}^{( j {ϕ}_{yy}^{l} )}\end{matrix} ) , , \qquad Eq . ( 6 )$$

where ϕ^{l} is the phase of the corresponding reflection coefficient. In this respect, the tangential reflected field of each polarization is based on the phases of both direct coefficients, namely ϕₓₓ^{l} and ϕ_{yy}^{l}. Reflectarray antennas can be classified as planar apertures and the far fields can be determined by using the Fast Fourier Transform (FFT) algorithm. For example, the FFT computes the current far field radiated by the reflectarray antenna.

The far field radiation pattern for X polarization can be expressed as:

E_{θ}^{X}=2 A cos φPₓ^{X}, Eq. (7),

E_{φ}^{X}=−2 A cos φ sin φPₓ^{X}, Eq. (8).

While, for Y polarization, the far field radiation pattern can be expressed as:

E_{θ}^{Y}=2 A sin φP_{y}^{Y}, Eq. (9),

E_{φ}^{Y}=−2 A cos φ cos φP_{y}^{Y}, Eq. (10),

where:

$$A = \frac{{jk}_{0} {e}^{- {jk}_{0} r}}{4 π r} . \qquad Eq . ( 11 )$$

In some implementations, the copolar component, for both linear polarizations, is obtained from the far field in spherical coordinates. Once the copolar far field radiation pattern is obtained, the squared field amplitude or gain is computed. For example, the gain can be estimated by computing the total power radiated by the feed. The forward projection operation also includes trimming the far field gain according to the mask thresholds (e.g., Tₘᵢₙ(u, v)≤G_{cp} (u, v)≤Tₘₐₓ(u,v)). For example, if the current gain of the reflectarray antenna is greater than Tₘₐₓ, then G_{cp} is decreased to Tₘₐₓ, and conversely, if G_{cp} is lesser than Tₘᵢₙ, then G_{cp} is increased to Tₘᵢₙ. The result of the trimming operation by the forward projection operation is a modified far field that complies with the antenna specifications.

The backward projection operation minimizes the distance between the trimmed gain and the current gain radiated by the antenna, thus obtaining a tangential reflected field that generates a radiation pattern that is closer to satisfy the antenna specifications. Thus, the backward projection operation can be expressed as:

\vec{E}_{ref,i+1}= [symbol] [ [symbol] (\vec{E}_{ref,i})]=min dist[Gi, [symbol] (\vec{E}_{ref,i})] Eq. (12).

In some implementations, the latter operation is performed by a minimization algorithm, such as the Levenberg-Marquardt Algorithm (LMA). The optimization variables may be the phases of the reflection coefficients, ϕₓₓ for X polarization and ϕ_{yy} for Y polarization. In other implementations, a direct optimization layout can be performed with the IA algorithm, where the optimization variables represent the dipole lengths instead of the phases of the reflection coefficients. In various implementations, the two polarizations can be synthesized independently. In some implementations, the backward projection operation with the LMA may include, among others, performing a gradient computation with a Jacobian matrix (J) and performing a matrix multiplication (J^{T}J).

A determination is made as to whether another process in the iterative pattern synthesis algorithm is available and if so then the process determines a convergence of the algorithm as to whether another step of the algorithm is available. In this respect, if the algorithm does not converge. This starts with the focus at the center of the reflectarray antenna, where a portion of elements are focused around the center. In various implementations, the focus is increased to additional elements around the center at each subsequent step by setting minimum and maximum threshold levels of illumination to optimize only a ring of cells about the center. The cells that need optimization (and/or improvement) may be selected according to the illumination level. In some implementations, the error after each step is computed to determine how to adjust the number of iterations and stop criteria.

Continuing with the process, the gain is increased to a second target gain that is greater than the first target gain. In some implementations, the gain is increased incrementally (e.g., by 0.5 dB increments). In other aspects, the increase in gain corresponds to a predetermined illumination level on a fixed number of reflectarray elements about a center of the reflectarray antenna within the coverage area. In this respect, the incremental increase in gain may correspond to the adjusted focused beam. The pattern synthesis is carried in multiple steps, gradually increasing the gain to further improve the convergence of the algorithm. The iterative pattern synthesis algorithm is performed on the initial phase distribution with the second target gain and then the target phase distribution on the reflectarray surface is determined by pattern synthesis. As used herein, the term “target phase distribution” may refer to the term “synthesized phase distribution” to denote its relation to the pattern synthesis, and the term can be used interchangeably without departing from the scope of the present disclosure.

A phase from the phase curve is compared to a phase of the target phase distribution for a reflectarray cell in a particular linear polarization and a determination is made as to whether the compared phases match and to determine if one or more dipole lengths on the reflectarray cell that correspond to a phase that matches the phase in the target phase distribution is adjusted for that reflectarray cell using the calculated phase curve. Geometric parameters of a reflectarray cell are refined from the synthesized phase distribution. For example, the dipole lengths of each reflectarray cell are adjusted such that the phase shift provided by that element matches the corresponding phase shift represented in the synthesized phase distribution.

In various implementations, a linear equation is used to approximate the value of the dipole size that provides the required phase shift. Subsequently, a first radiation pattern of the reflectarray antenna using predetermined reflection coefficients is calculated for each linear polarization. For example, the first radiation pattern may be generated using the analytical representation of the radiated far fields at Eqs. 7-10. A second radiation pattern of the reflectarray antenna with the adjusted one or more dipole lengths is calculated for each linear polarization. The second radiation pattern may be generated by performing the FFT operation on the synthesized phase distribution. In various implementations, the second radiation pattern may include the copolar component of the far field and/or the crosspolar component of the far field, in the u-v plane for the whole visible region. The geometric parameters of the reflectarray antenna are validated by comparing the first radiation pattern to the second radiation pattern. In various implementations, the two radiation patterns may be compared to determine any differences in gain and/or losses. In some implementations, main cuts in elevation and azimuth for both linear polarizations along with mask thresholds are obtained to better determine how the specifications are met. In various implementations, the Side Lobe Level (SLL) can be observed relative to the minimum and maximum threshold levels.

The validated geometric parameters are provided to fabricate the reflectarray antenna, where each cell is fabricated with the optimized dipole lengths and cell geometric parameters, which yields the target phase distribution for both linear polarizations. In various implementations, the reflectarray antenna design with validated geometric parameters are provided by an electronic device through a network interface of the electronic device, over a network, to another electronic device that executes one or more fabrication processes.

Once the reflectarray is fabricated, it is ready for placement and operation to provide enhanced visibility in NLOS areas. Note that even after the design is completed and the reflectarray is manufactured and placed in an environment, the reflectarray may still be adjusted with the use of say rotation mechanisms attached to the reflectarray. In addition to many configurations, the reflectarrays disclosed herein can generate a focused, directed narrow beam or a beam width greater or smaller than an incident wave's beam width. The reflectarrays are low cost, easy to manufacture and set up; they may be passive (or active with an integrated transmitter) and achieve higher gains. It is appreciated that these reflectarrays effectively enable the desired performance and visibility for a radar system.

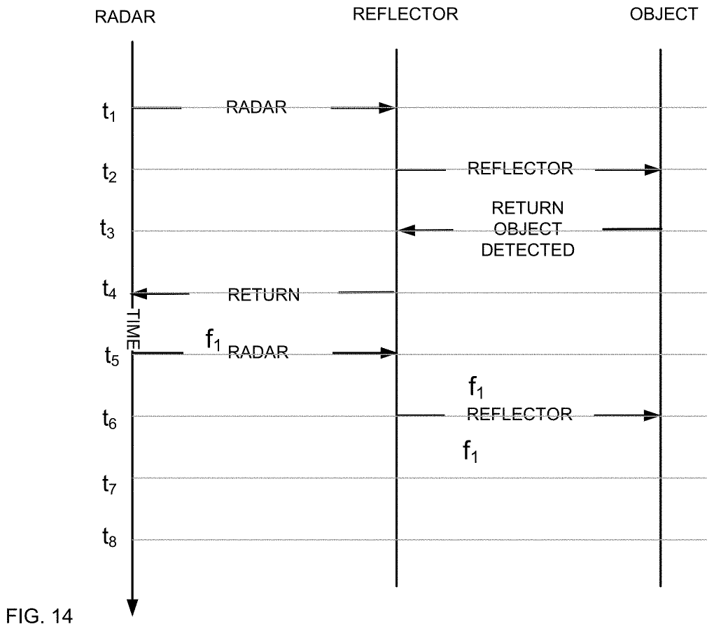

FIG. 14 illustrates a signal flow diagram for a reflector system in operation, where a radar signal is transmitted to a reflector at time t₁. At time t₂ the reflector signal is directed to a NLOS area and returns from an object in that area at time t₃. The signal reflects from the reflector as a return to radar unit at time t₄. If no object is detected, the reflector signal does not return, as illustrated by the radar signal transmitted to the reflector at time t₅ and the reflector signal directed to the NLOS area at time t₆.

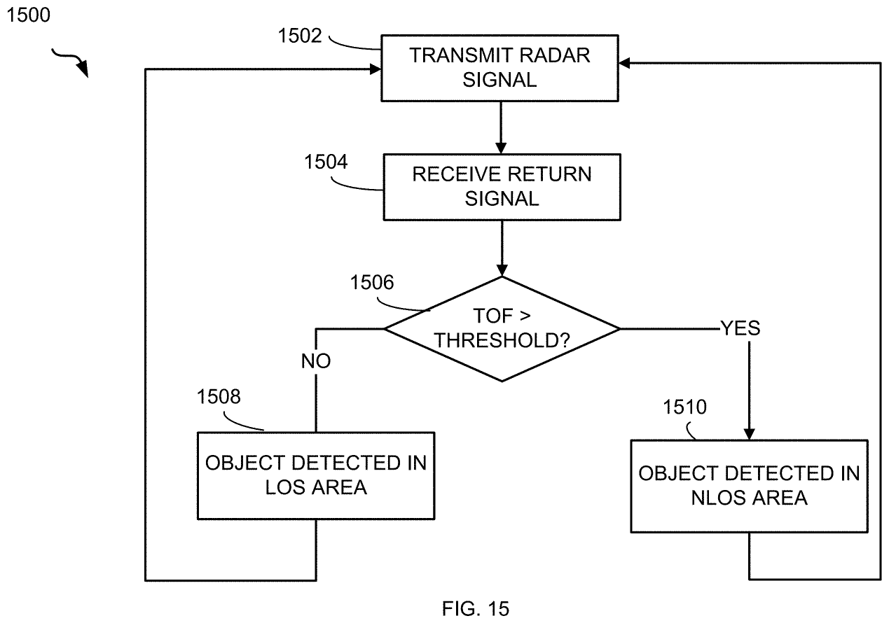

FIG. 15 illustrates process 1500 of a radar module in operation with a reflector. The radar transmits a radar signal, 1502, and receives a return signal, 1504. If the ToF is greater than a threshold value, 1506, the radar determines that the object is detected in the non-line of sight (NLOS) area, 1510, else the object is detected in the line of sight (LOS) area, 1508 and is a direct reflection.

FIG. 16 illustrates a reflectarray 1600 in accordance with various embodiments. As shown in FIG. 16, location A 1602 is identified at distance D0 from the reflectarray 1600 in a Cartesian (x, y, z) coordinate system where reflectarray 1600 is positioned in the center of the coordinate system. The reflectarray antenna 1600 has a relative boresight in this position along the y-axis. The location A 1602 has an elevation angle θ₀ and an azimuth angle φ₀. The reflectarray 1600 can be configured to reflect incident RF waves from location A 1602 at a distance D₁ from the reflectarray antenna 1600 with θ₁ elevation and φ₁ azimuth angles toward location B 1604, which represents the NLOS area.

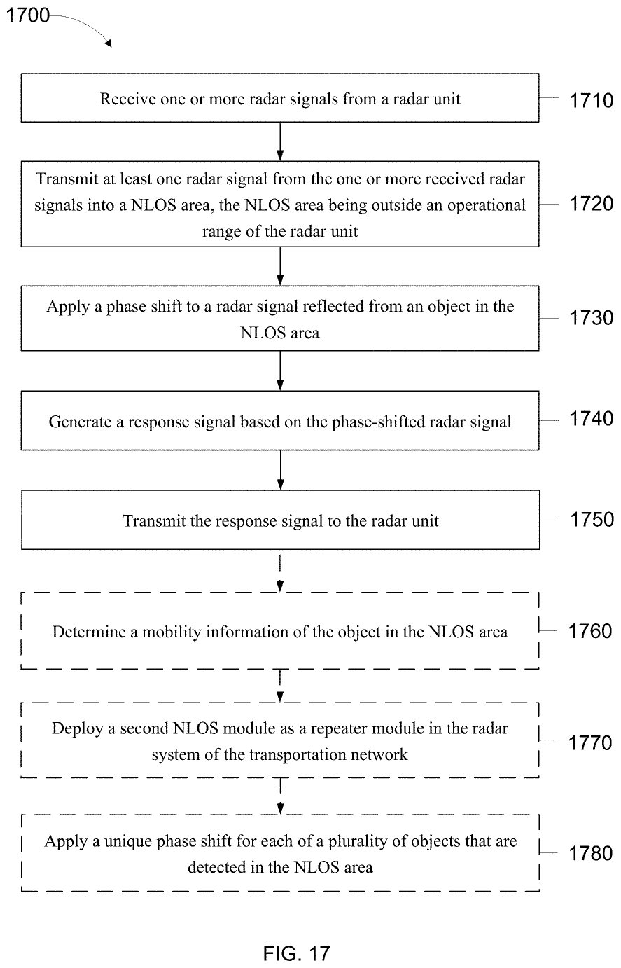

FIG. 17 illustrates a flowchart for a method 1700 of using a radar system in accordance with one or more implementations of the subject technology. The method 1700 includes, at step 1710, receiving one or more radar signals from a radar unit. The method 1700 includes, at step 1720, transmitting at least one radar signal from the one or more received radar signals into a NLOS area, the NLOS area being outside an operational range of the radar unit. The method 1700 includes, at step 1730, applying a phase shift to a radar signal reflected from an object in the NLOS area; at step 1740, generating a response signal based on the phase-shifted radar signal, and at step 1750, transmitting the response signal to the radar unit.

In various implementations of the method 1700, the phase shift applied to the radar signal reflected from the object in the NLOS area corresponds to a first frequency or a frequency change that identifies the NLOS module. In various implementations, one or more received radar signals include a Frequency Modulated Continuous Wave (FMCW).

In various implementations, the method 1700 optionally includes, at step 1760, determining a mobility information of the object in the NLOS area, the mobility information comprising at least one of a physical distance, a speed, or a velocity of the object with respect to a position of the NLOS module.

In various implementations, the NLOS module is part of a radar system operationally deployed in a transportation network. In various implementations, the method 1700 optionally includes, at step 1770, deploying a second NLOS module as a repeater module in the radar system of the transportation network.

In various implementations, the method 1700 optionally includes, at step 1780, applying a unique phase shift for each of a plurality of objects that are detected in the NLOS area. In various implementations, the phase shift is applied via a silicon germanium (SiGe) based phase shifting module comprising a radio frequency integrated circuit (RFIC).

In accordance with various embodiments, a non-line of sight (NLOS) module is provided in detail. The NLOS module includes a receive antenna configured to receive one or more radar signals from a radar unit, a transmit antenna configured to transmit at least one radar signal from the one or more received radar signals into a NLOS area, the NLOS area being outside an operational range of the radar unit, and a phase shifting module coupled between the receive antenna and the transmit antenna. In various implementations, the phase shifting module can be configured to apply a phase shift to a radar signal reflected from an object in the NLOS area.

In various implementations, the receive antenna is further configured to generate a response signal that is transmitted to the radar unit based on the received reflected radar signal from the object in the NLOS area. In accordance with various embodiments, the phase shift corresponds to a first frequency or a frequency change that identifies the NLOS module. In various implementations, the one or more radar signals comprises a Frequency Modulated Continuous Wave (FMCW) for determining a mobility information of the object in the NLOS area. In various embodiments, the mobility information includes, among many others, at least a physical distance, a speed, or a velocity of the object with respect to a position of the NLOS module. In various implementations, the NLOS module is part of a radar system operationally deployed in a transportation network.

In various embodiments, the phase shifting module can be configured to apply a unique phase shift for each of a plurality of objects that are detected in the NLOS area. In various implementations, the phase shifting module includes a silicon germanium (SiGe) based radio frequency integrated circuit (RFIC). In various implementations, the NLOS module is one of a plurality of radar repeater modules deployed in a transportation network.

In accordance with various implementations, a method of using a non-line of sight (NLOS) module is provided. The method includes receiving one or more radar signals from a radar unit, transmitting at least one radar signal from the one or more received radar signals into a NLOS area, the NLOS area being outside an operational range of the radar unit, applying a phase shift to a radar signal reflected from an object in the NLOS area, generating a response signal based on the phase-shifted radar signal, and transmitting the response signal to the radar unit.

In various implementations, the phase shift applied to the radar signal reflected from the object in the NLOS area corresponds to a first frequency or a frequency change that identifies the NLOS module. In various implementations, one or more received radar signals can include a Frequency Modulated Continuous Wave (FMCW). In various implementations, the method further includes determining a mobility information of the object in the NLOS area. As described herein, the mobility information can include at least one of a physical distance, a speed, or a velocity of the object with respect to a position of the NLOS module. In various implementations, the NLOS module is part of a radar system operationally deployed in a transportation network and the method can further include deploying a second NLOS module as a repeater module in the radar system of the transportation network.

In various implementations, the method optionally includes applying a unique phase shift for each of a plurality of objects that are detected in the NLOS area. In various implementations, the phase shift can be applied via a silicon germanium (SiGe) based phase shifting module comprising a radio frequency integrated circuit (RFIC), or any other suitable components as described herein.

In various implementations, a non-line of sight (NLOS) module is disclosed. The NLOS module includes a substrate, an attachment structure that positions the NLOS module on a fixed surface, the attachment structure coupled to a first side of the substrate, and a reflector structure including a plurality of unit cells. The unit cells can be configured to reflect an incident wave from a radar unit into a NLOS area of the radar unit. In accordance with various implementations, a beam width of the reflected wave from the reflector structure is greater than a beam width of the incident wave from the radar unit. In various implementations, the NLOS area is outside an operational range of the radar unit. In various implementations, the NLOS module is positioned proximate a curved portion of a train track. In various implementations, the NLOS module is positioned proximate a tunnel. In various implementations, the plurality of unit cells includes at least two different cell sizes. In various implementations, the reflector structure includes a reflector configuration based on the beam width of the incident want, the beam width of the reflected wave, and the NLOS area of the radar unit.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A non-line of sight (NLOS) module, comprising:
a receive antenna configured to receive one or more radar signals from a radar unit;
a transmit antenna configured to transmit at least one radar signal from the one or more received radar signals into a NLOS area, the NLOS area being outside an operational range of the radar unit; and
a phase shifting module coupled between the receive antenna and the transmit antenna,
wherein the phase shifting module is configured to apply a phase shift to a radar signal reflected from an object in the NLOS area.

2. The NLOS module of claim 1, wherein the receive antenna is further configured to generate a response signal that is transmitted to the radar unit based on the received reflected radar signal from the object in the NLOS area.

3. The NLOS module of claim 1, wherein the phase shift corresponds to a first frequency or a frequency change that identifies the NLOS module.

4. The NLOS module of claim 1, wherein the one or more radar signals comprises a Frequency Modulated Continuous Wave (FMCW) for determining a mobility information of the object in the NLOS area, the mobility information comprising at least one of a physical distance, a speed, or a velocity of the object with respect to a position of the NLOS module.

5. The NLOS module of claim 1, wherein the NLOS module is part of a radar system operationally deployed in a transportation network.

6. The NLOS module of claim 1, wherein the phase shifting module is further configured to apply a unique phase shift for each of a plurality of objects that are detected in the NLOS area.

7. The NLOS module of claim 1, wherein the phase shifting module comprises a silicon germanium (SiGe) based radio frequency integrated circuit (RFIC).

8. The NLOS module of claim 1, wherein the NLOS module is one of a plurality of radar repeater modules deployed in a transportation network.

9. A method of using a non-line of sight (NLOS) module, comprising:
receiving one or more radar signals from a radar unit;
transmitting at least one radar signal from the one or more received radar signals into a NLOS area, the NLOS area being outside an operational range of the radar unit;
applying a phase shift to a radar signal reflected from an object in the NLOS area;
generating a response signal based on the phase-shifted radar signal; and
transmitting the response signal to the radar unit.

10. The method of claim 9, wherein the phase shift applied to the radar signal reflected from the object in the NLOS area corresponds to a first frequency or a frequency change that identifies the NLOS module.

11. The method of claim 9, wherein the one or more received radar signals comprises a Frequency Modulated Continuous Wave (FMCW), the method further comprising:
determining a mobility information of the object in the NLOS area, the mobility information comprising at least one of a physical distance, a speed, or a velocity of the object with respect to a position of the NLOS module.

12. The method of claim 9, wherein the NLOS module is part of a radar system operationally deployed in a transportation network, the method further comprising:
deploying a second NLOS module as a repeater module in the radar system of the transportation network.

13. The method of claim 9, further comprising:
applying a unique phase shift for each of a plurality of objects that are detected in the NLOS area.

14. The method of claim 9, wherein the phase shift is applied via a silicon germanium (SiGe) based phase shifting module comprising a radio frequency integrated circuit (RFIC).

15. A non-line of sight (NLOS) module, comprising:
a substrate;
an attachment structure that positions the NLOS module on a fixed surface, the attachment structure coupled to a first side of the substrate; and
a reflector structure comprising a plurality of unit cells, wherein the plurality of unit cells are configured to reflect an incident wave from a radar unit into a NLOS area of the radar unit,
wherein a beam width of the reflected wave from the reflector structure is greater than a beam width of the incident wave from the radar unit.

16. The NLOS module of claim 15, wherein the NLOS area is outside an operational range of the radar unit.

17. The NLOS module of claim 15, wherein the NLOS module is positioned proximate a curved portion of a train track.

18. The NLOS module of claim 15, wherein the NLOS module is positioned proximate a tunnel.

19. The NLOS modules of claim 15, wherein the plurality of unit cells comprises at least two different cell sizes.

20. The NLOS module of claim 15, wherein the reflector structure comprises a reflector configuration based on the beam width of the incident want, the beam width of the reflected wave, and the NLOS area of the radar unit.
